(19) United States
(12) Patent Application Publication
(10) Pub. No.: US 2010/0275796 A1
(43) Pub. Date: Nov. 4, 2010

(54) PATTERN FORMATION BOARD STRUCTURE

(76) Inventor: SHIH-FENG LEE, Wu-Ku Industrial Zone (TW)

Correspondence Address: LEONG C LEI, PMB # 1008, 1867 YGNACIO VALLEY ROAD, WALNUT CREEK, CA, 94598, US

(21) Appl. No.: 12/431,771

(22) Filed: Apr. 29, 2009

(51) Int. Cl. B05C 17/06

(52) U.S. Cl. 101/127

(57) ABSTRACT

A pattern formation board structure is disclosed. The board structure comprises a main board having hollow stripes with a specific main pattern; a secondary board being an extension from the edge of the main board having hollow stripes with a secondary pattern corresponding to the main pattern of the main board at a different position such that the respective shape and size of the secondary pattern and the main pattern are similar; thereby the main board and the secondary board form into a pattern formation board, by spraying or coating the hollow stripes, a plurality of patterns of multiple colors can be obtained.

### (a) TECHNICAL FIELD OF THE INVENTION

The present invention relates to board structure, and in particular, to a board structure for formation or drawing patterns.

### (b) DESCRIPTION OF THE PRIOR ART

FIG. 1 is a conventional pattern formation board which comprises a board body 4 having a plurality of hollow stripes forming into specific pattern 41. In application, the main board is positioned onto the article which requires the pattern. Coating or pigment is sprayed onto the hollow stripes until a pattern is formed on the surface. When different color of various pattern is to be formed on a surface, a masking tape is used to cover the position where color is yet to be provided. This action is laborious and time consuming and it is not convenient in operation. Accordingly, it is an object of the present invention to provide a pattern formation board structure which mitigates the above drawback.

### SUMMARY OF THE INVENTION

Accordingly, it is an object of the present invention to provide a pattern formation board structure comprising a main board having hollow stripes with a specific main pattern; a secondary board being an extension from the edge of the main board having hollow stripes with a secondary pattern corresponding to the main pattern of the main board at a different position such that the respective shape and size of the secondary pattern and the main pattern are similar; thereby the main board and the secondary board form into a pattern formation board, by spraying or coating the hollow stripes, a plurality of patterns of multiple colors can be obtained.

Yet still an object of the present invention to provide a pattern formation board structure, wherein a connection section is formed between the main board and the secondary board, and the connection section is provided with a folding line facilitating the folding of the secondary board onto the main board.

A further object of the present invention is to provide a pattern formation board structure, wherein the back section of the main board is provided with glue material for the adhesion of vertically-hang objects.

Another object of the present invention is to provide a pattern formation board structure, wherein the surface of the secondary board is undergone electro-statically treatment such that the secondary board is adhered onto the main board.

Yet still another object of the present invention is to provide a pattern formation board structure, wherein the four corners of the main board are extended with a plurality of suspended sub-secondary boards which are diagonally adhered onto the main board, allowing the spraying or coating of different color pigments onto the hollow stripes to form various multiple colors patterns.

Other objects, and advantages will become more apparent in view of the following detailed description in conjunction with the accompanying drawings.

### BRIEF DESCRIPTION OF THE DRAWINGS

FIG. 1 is a plan view of a conventional pattern formation board.

FIG. 2 is a perspective view of the pattern formation board of the present invention.

FIG. 3 is a plan view of the pattern formation board of the present invention.

FIGS. 4 and 5 show a preferred embodiment of application of the pattern formation board of the present invention.

FIGS. 6 and 7 show completed patterns.

FIG. 8 is a plan view of another preferred embodiment of the present invention.

FIG. 9 is a completed pattern of another preferred embodiment of the present invention.

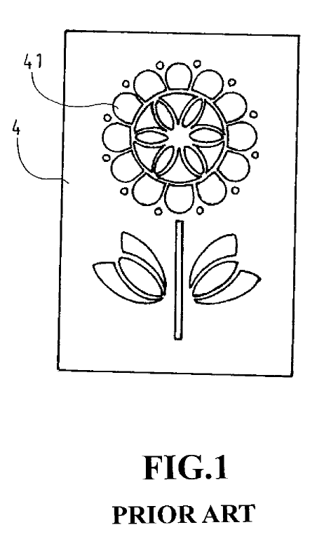

### DETAILED DESCRIPTION OF THE PREFERRED EMBODIMENTS

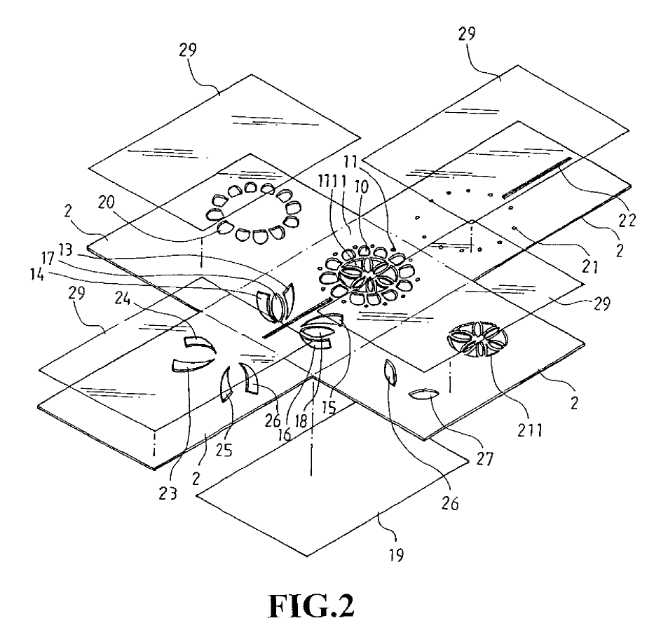

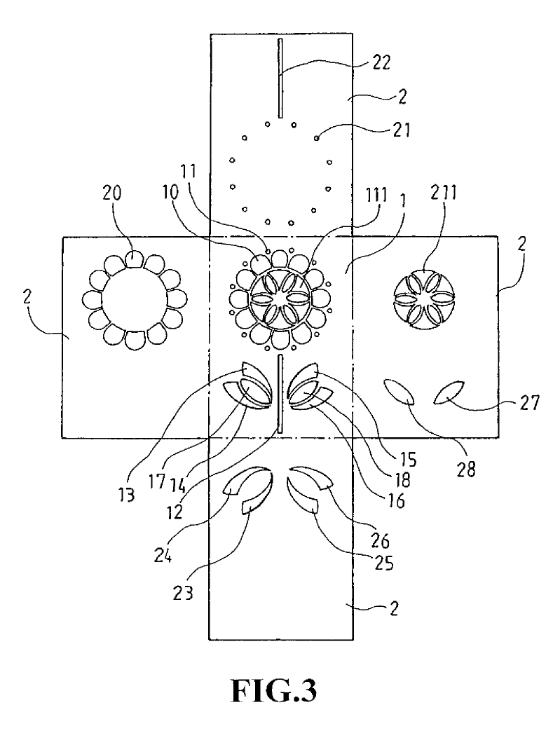

Referring to FIGS. 2 and 3, there is shown a pattern formation board structure comprising a main board 1 and a plurality of secondary board 2 extended along the top, bottom, left and right edge of the main board 1. There is a connection section positioned between the main board 1 and the secondary board 2. The connection section is provided with a folding line 3 which facilitates the folding of the secondary board 2 onto the main board 1.

The main board 1 is provided with hollow stripes forming into a specific pattern. In accordance with a preferred embodiment, the main board 1 has a flowery board 10 having a flower 11 design at the edge. The flowery board 10 is provided with a flower bulb 111 at the center thereof. The lower section of the flower design 11 is a stalk 12, and at the sides of the stalk 12 are left side leave 13, 14, right side leave 15, 16, leave buds 17, 18 and the rear surface of the flowery board 10 is provided with glue material covered with a peel-off paper 19.

The secondary board 2 is provided with hollow stripes forming a secondary pattern which corresponds to that of the main board 1. In a preferred embodiment, the secondary board 2 comprises an independent flowery board 20, flower design 21 at the edge of the flowery board 20, and the center of the flowery board 20 is the bulb 211, flower stalk 22 and left side leave 23, 24, right side leave 25, 26, leave buds 27, 28. The secondary pattern has the same shape, position and size as that of the main board 1. The surface of the secondary board has undergone an electrostatic treatment and is adhered with a peel-off paper 29.

The above components form into a pattern formation board structure. In application the main board 1 is positioned horizontally onto an object which requires the pattern or the peel-off paper 19 is removed, the main board 1 is adhered to the vertical object which requires the pattern. The peel off paper 29 at the left, right, top and button edge of the secondary board 2 are removed. Along the folding line 3, the board 2 is folded inwardly. The secondary board 2 is adhered onto the main board 1 as a result of electrostatic, and spray pigment or coating to the hollow stripes with various colors, a pattern of multiple colors is obtained.

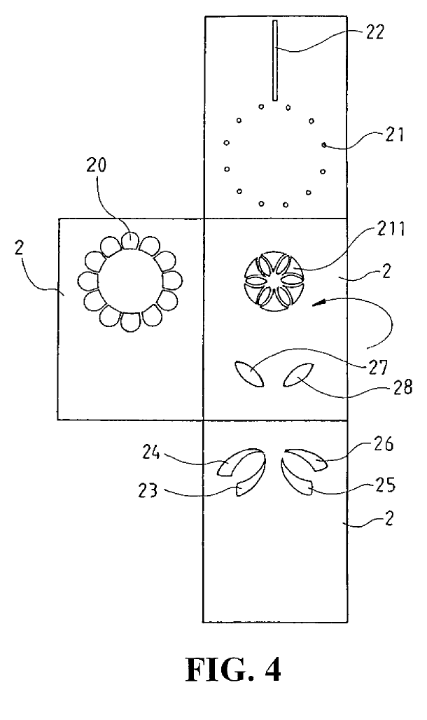

Referring to FIGS. 2 and 4, in application of the pattern formation board structure, the main board 1 is positioned onto the article or an object which requires a pattern, or the peel off paper 19 is removed, and the main board 1 is adhered onto the vertical object which needs the pattern. The peel off paper on the secondary board 2 is removed and is folded along the folding line onto the main board 1 and different color is coated or sprayed thereon. As shown in the figure, the secondary board 2 having the flower bulb 211 and the leave bud 27, 28 is folded onto the main board 1 such that the outer position of the flower bulb 211 and the leave buds 27, 28 are covered, and pigment is sprayed and the article is printed with flower bulb 211 and leave buds 27, 28 design or patterns.

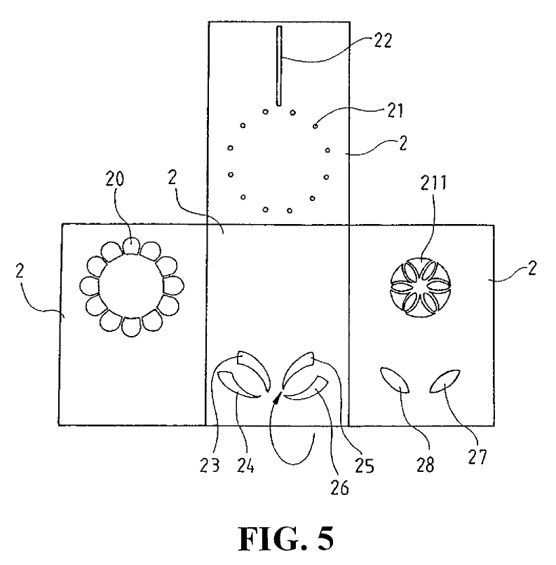

As shown in FIG. 2 and FIG. 5, after the flower bulb 211 and leave buds 27, 28 design or pattern are formed, other secondary board 2 is folded inwardly and spray the hollow stripes with different colors. As shown in the figure, the secondary board 2 having left side leave 23, 24, the right side leave 25, 26 patterns are folded onto the main board 1 such that the secondary board is adhered onto the main board 1 and the outer position of the left side leave 23, 24 and the right side leave 25, 26 are covered. After pigment is applied or color is sprayed, the surface of the object is printed with pattern of left side leave 23, 24 and right side leave 25, 26.

In the entire process mentioned above, the secondary board 2 with flower 21 and flower stalk 22, or secondary board 2 with flowery board 20 can also be folded inwardly and the hollow stripes are sprayed with pigment. A multiple colors pattern is obtained.

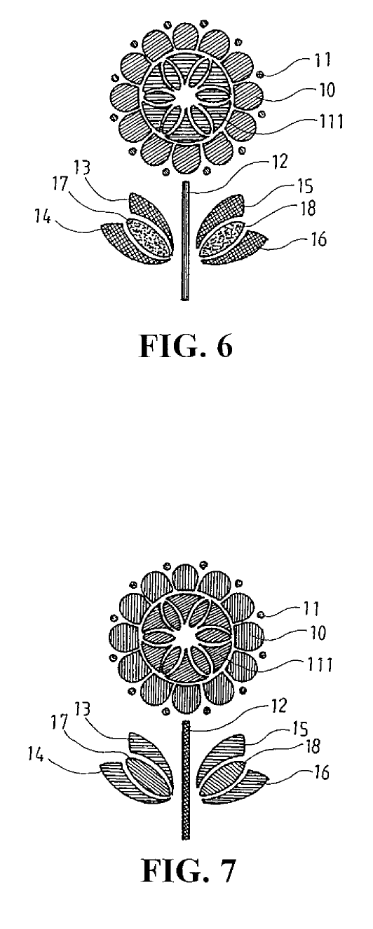

As shown in FIGS. 6 and 7, there is shown a complete pattern formed using the pattern formation board structure of the present invention. There is shown the flowery board 10, the flower designs 11 at the edge of the flowery board 10, the flower bulb 111 at the center of the flowery board 10, the flower stalk 12 at the lower section of the flower 11 and the left side leave 13, 14, right side leave 15, 16, leave buds 17, 18 are provides with different color.

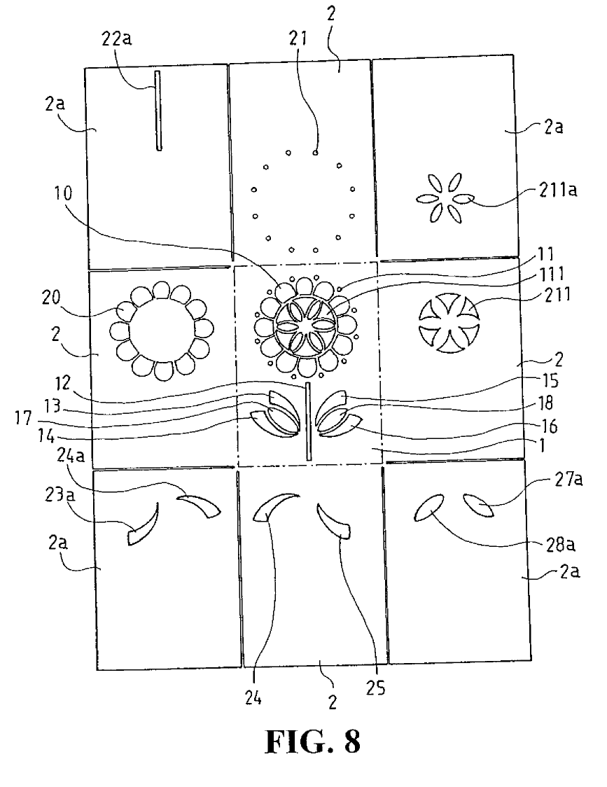

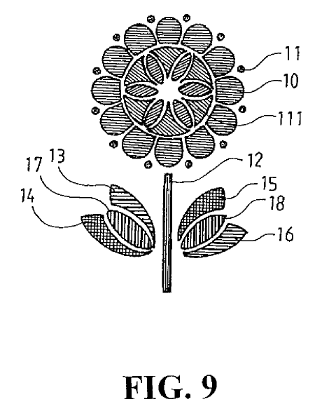

Referring to FIG. 8, the main board is provided with four corners which can be extended with a plurality of sub-secondary board 2a. The board 2a is adhered diagonally onto the main board 1. Similarly, the main board 1 is provided with main pattern, and the secondary board 2a is provided with flowery board 20a, flower design 21a, flower bulb 211a, flower stalk 22a and left side leave 23a, 24a, right side leave 25a, 26a, leave buds 27a, 28a (partial shown) such that the secondary board 2a is adhered onto the main board 1 diagonally and the hollow stripes are coated or sprayed with pigments or paint of different colors. A completed pattern is shown in FIG. 9.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A pattern formation board structure comprising:
a main board having hollow stripes with a specific main pattern;
a secondary board being an extension from the edge of the main board having hollow stripes with a secondary pattern corresponding to the main pattern of the main board at a different position such that the respective shape and size of the secondary pattern and the main pattern are similar;
thereby the main board and the secondary board form into a pattern formation board, by spraying or coating the hollow stripes, a plurality of patterns of multiple colors can be obtained.

2. The pattern formation board structure of claim 1, wherein a connection section is formed between the main board and the secondary board, and the connection section is provided with a folding line facilitating the folding of the secondary board onto the main board.

3. The pattern formation board structure of claim 1, wherein the back section of the main board is provided with glue material for the adhesion of vertically-hang objects.

4. The pattern formation board structure of claim 1, wherein the surface of the secondary board is undergone electro-statically treatment such that the secondary board is adhered onto the main board.

5. The pattern formation board structure of claim 1, wherein the four corners of the main board are extended with a plurality of suspended sub-secondary boards which are diagonally adhered onto the main board, allowing the spraying or coating of different color pigments onto the hollow stripes to form various multiple colors patterns.
